(19) United States
(12) Patent Application Publication
(10) Pub. No.: US 2026/0279060 A1
(43) Pub. Date: Sep. 17, 2026

(54) MOTION ANALYZER, MOTION ANALYSIS METHOD, AND NON-TRANSITORY RECORDING MEDIUM

(71) Applicant: NEC Corporation, Tokyo (JP)

(72) Inventors: Kazuaki ISHIKAWA, Tokyo (JP); Akihiko Onita, Tokyo (JP); Kenichi Asada, Tokyo (JP); Yuya Matsumoto, Tokyo (JP)

(73) Assignee: NEC Corporation, Tokyo (JP)

(21) Appl. No.: 19/409,884

(22) Filed: Dec. 5, 2025

(30) Foreign Application Priority Data
Mar. 14, 2025 (JP) 2025-040862

(51) Int. Cl. G06V 20/52; G06T 7/20; G06V 20/70

(52) U.S. Cl. CPC G06V 20/52; G06T 7/20; G06V 20/70

(57) ABSTRACT

A motion analyzer includes a first display unit that displays a graph of cycle time obtained by measuring time required for each process while a worker repeatedly performs a predetermined process, a first reception unit that receives selection of a process executed at a specific time on the graph, a second display unit that displays, on a screen, a work video obtained by capturing a hand of the worker in the process executed at the specific time and a model video of the process, a second reception unit that receives input of a comment on the work video, and a third display unit that displays the comment at a corresponding position on the graph.

This application is based upon and claims the benefit of priority from Japanese Patent Application No. 2025-040862, filed on March 14, 2025, the disclosure of which is incorporated herein in its entirety by reference.

### TECHNICAL FIELD

The present disclosure relates to a motion analyzer and the like.

### BACKGROUND ART

In a production site, there is a technique of imaging and analyzing work performed in the site in order to allow workers to check the work more efficiently. For example, WO 2023/017647 A1 discloses a technique capable of displaying a video obtained by capturing a worker to be compared with a skilled worker and checking the behavior of the worker in comparison with the skilled worker.

### SUMMARY

In a production site, it is required to more easily grasp a place where the work content of a worker needs to be improved.

In order to solve the above problem, an object of the present disclosure is to provide a motion analyzer and the like capable of more easily grasping a place where the work content of a worker needs to be improved.

In order to solve the above problem, a motion analyzer of the present disclosure includes a first display unit for displaying a graph of cycle time obtained by measuring time required for each process while a worker repeatedly performs a predetermined process, a first reception unit for receiving selection of a process executed at a specific time on the graph, a second display unit for displaying, on a screen, a work video obtained by capturing a hand of the worker in the process executed at the specific time and a model video of the process, a second reception unit for receiving input of a comment on the work video, and a third display unit for displaying the comment at a corresponding position on the graph.

A motion analysis method of the present disclosure causes a computer to execute processing including displaying a graph of cycle time obtained by measuring time required for each process while a worker repeatedly performs a predetermined process, receiving selection of a process executed at a specific time on the graph, displaying, on a screen, a work video obtained by capturing a hand of the worker in the process executed at the specific time and a model video of the process, receiving input of a comment on the work video, and displaying the comment at a corresponding position on the graph.

A program of the present disclosure causes a computer to execute processing including displaying a graph of cycle time obtained by measuring time required for each process while a worker repeatedly performs a predetermined process, receiving selection of a process executed at a specific time on the graph, displaying, on a screen, a work video obtained by capturing a hand of the worker in the process executed at the specific time and a model video of the process, receiving input of a comment on the work video, and displaying the comment at a corresponding position on the graph.

According to the present disclosure, it is possible to more easily grasp a place where the work content of a worker needs to be improved.

### BRIEF DESCRIPTION OF THE DRAWINGS

Exemplary features and advantages of the present disclosure will become apparent from the following detailed description if taken with the accompanying drawings in which:

FIG. 1 is a diagram illustrating an example of a configuration of a motion analyzer system in the present disclosure;

FIG. 2 is a diagram illustrating an example of a configuration of a motion analyzer in the present disclosure;

FIG. 3 is a view illustrating an example of an administration screen of an administrator in the present disclosure;

FIG. 4 is a diagram illustrating an example of an operation flow of the motion analyzer in the present disclosure;

FIG. 5 is a diagram illustrating an example of a configuration of the motion analyzer in the present disclosure;

FIG. 6 is a diagram illustrating an example of a configuration of the motion analyzer in the present disclosure;

FIG. 7 is a view illustrating an example of the administration screen of the administrator in the present disclosure;

FIG. 8 is a diagram illustrating an example of a configuration of the motion analyzer in the present disclosure;

FIG. 9 is a view illustrating an example of the administration screen of the administrator in the present disclosure;

FIG. 10 is a diagram illustrating an example of an operation flow of the motion analyzer in the present disclosure; and

FIG. 11 is a diagram illustrating an example of a configuration of hardware in the present disclosure.

### EXAMPLE EMBODIMENT

### First Example Embodiment

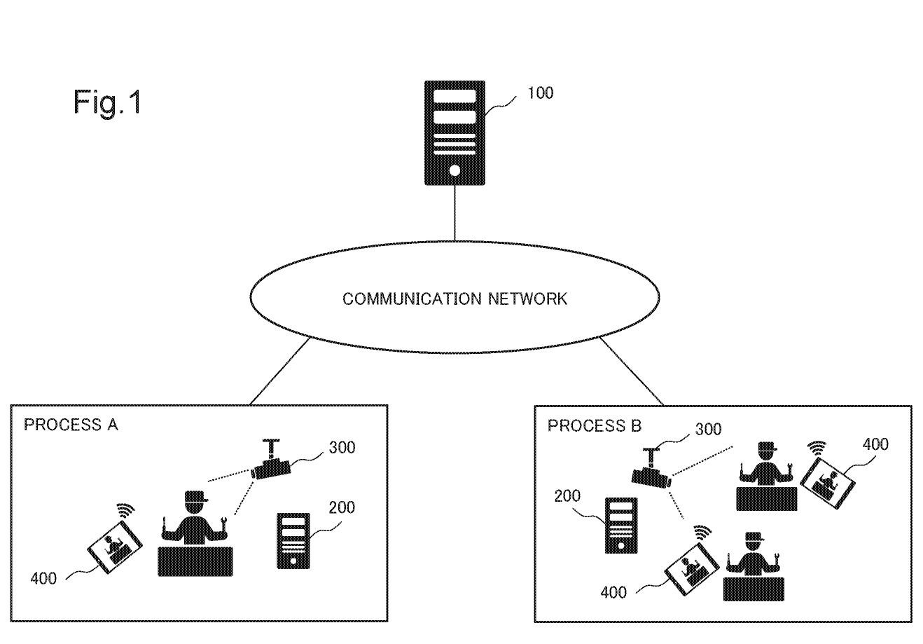

Example embodiments of the present disclosure will be described in detail with reference to the drawings. FIG. 1 is a diagram illustrating an example of a configuration of a motion analyzer system. The motion analyzer system is a system for extracting a problem of improvement in each process of a factory. The motion analyzer system includes a motion analyzer 100, and an edge 200, a camera 300, and a terminal device 400 in each process of the factory. The motion analyzer 100 is connected to each of the edge 200, the camera 300, and the terminal device 400 via a network. In FIG. 1, two processes of Process A and Process B are illustrated, but the number of processes is not limited to the example of FIG. 1.

The edge 200 is a system that is installed in the factory for analyzing an image obtained by capturing a work process of a worker and is an endpoint device in the motion analyzer system. In the example of FIG. 1, the edge 200 is used to analyze worker performance.

The camera 300 is used to capture the work process of the worker, and basically one camera is provided in one process.

The terminal device 400 is a terminal for displaying an image for the worker to check the work content and displays a model video obtained by capturing the hands of a skilled worker in a process in which the worker works.

The terminal device 400 may have an image processing function, and may be configured to output an alert in a case where it is detected that a work video obtained by capturing the hands of the worker during the work process with the camera 300 and the model video obtained by capturing the hands of the skilled worker are different by equal to more than a predetermined value.

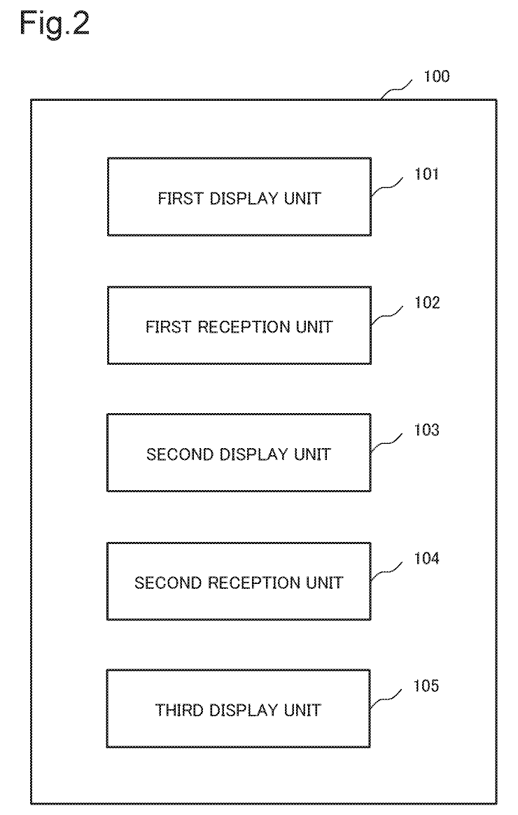

Here, an example of a configuration of motion analyzer 100 will be described. FIG. 2 is a diagram illustrating an example of the configuration of the motion analyzer 100. The motion analyzer 100 includes, as a basic configuration, a first display unit 101, a first reception unit 102, a second display unit 103, a second reception unit 104, and a third display unit 105.

The first display unit 101 is a means for displaying a graph of the cycle time, obtained by measuring the time required for each process while the worker repeatedly performs a predetermined process, on an administration screen of an administrator. For example, the first display unit 101 displays it in a bar graph format with the work time on the horizontal axis and the time required for the work on the vertical axis. In the present disclosure, a period from start to end of a single or multiple pieces of work is defined as one cycle, and the time required for one cycle is defined as a cycle time. More specifically, in the case of the single work, the time required from the start to the end of the work is set as the cycle time. In the case of continuous multiple pieces of work, the time required from the start to the end of a series of work groups is defined as a cycle time. The cycle time is measured using video data captured by the camera 300 or the work start, and end time data analyzed by the edge 200. The start point and the end point of measurement are defined in advance according to the nature of the work and are appropriately set for each process; for example, a period from pickup of a component to arrangement of a product is set as one cycle.

The first reception unit 102 receives selection of a process executed at a specific time on the displayed cycle time graph via an input means of an administrator terminal. For example, by an operator placing a cursor on or clicking a place with a mouse near a bar graph of which captured video the operator intends to check, the first reception unit 102 receives selection of this process.

The second display unit 103 displays a work video obtained by capturing the hands of the worker in the process executed at the specific time and a model video of the process on the administration screen of the administrator. The work video and the model video are displayed side by side on the screen, for example. The second display unit 103 may display the work video and the model video on the same screen or may display the work video and the model video on different screens.

The second reception unit 104 receives input of a comment on the displayed work video via the input means of the administrator terminal. The second reception unit 104 may receive a comment in a text format or may receive a comment input by voice.

The third display unit 105 displays the input comment at a corresponding position on the graph of the cycle time. More specifically, the third display unit 105 displays the comment in a balloon format at the top of the bar graph corresponding to the process for which the comment has been input.

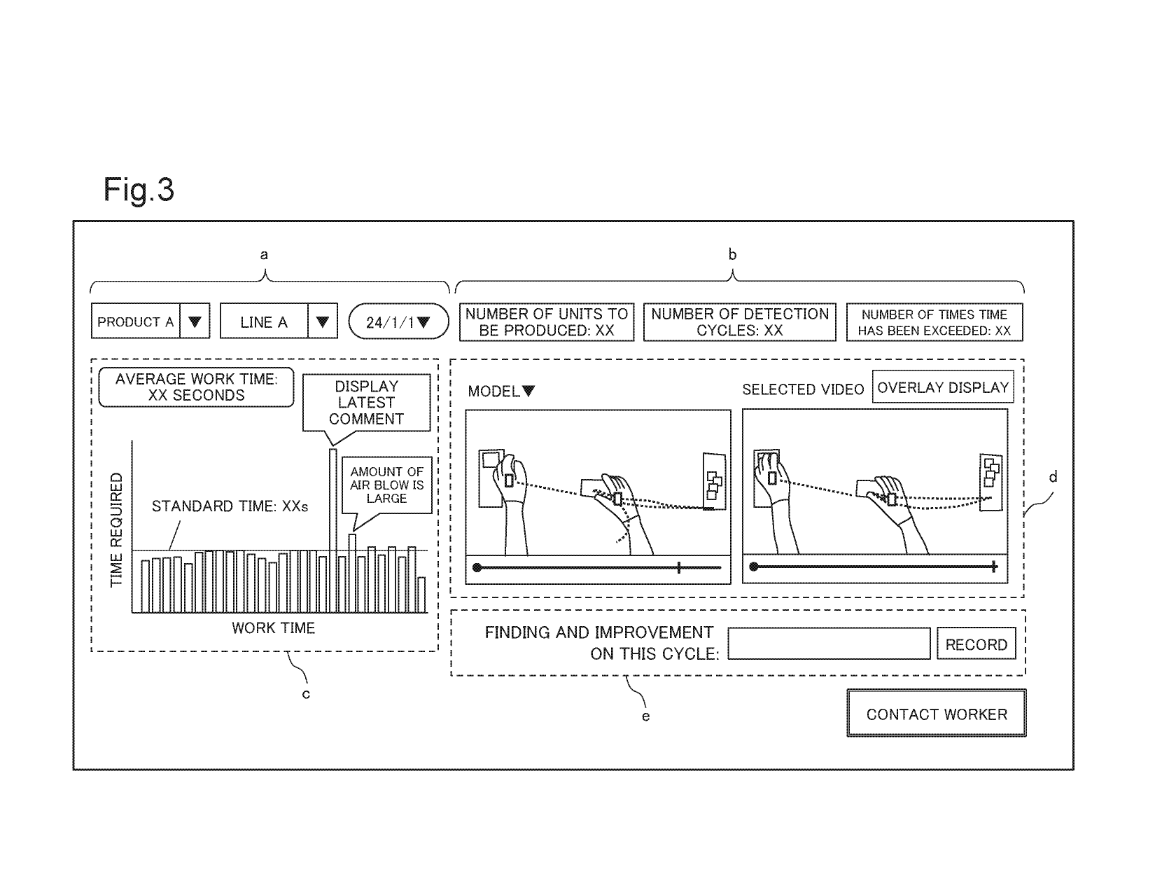

Next, with reference to FIG. 3, a description will be given of a user interface for comparing a work video obtained by capturing the hands of a worker captured by the camera 300 with a model video obtained by capturing the hands of a skilled worker. FIG. 3 is a view illustrating an example of a screen to be displayed in the administration screen of the administrator in the present disclosure.

On the screen illustrated in FIG. 3, an area a for selecting a process to be displayed, an area b for displaying information on the number of units produced in the selected process, an area c for displaying a graph of a cycle time, an area d for displaying a work video obtained by capturing the hands, and an area e for receiving input of a comment on the work video are displayed.

In the area, the product, the line, and the captured date are selectable in order for the operator to select a process of which graph of the cycle time and work video the operator intends to display. In the area b, the number of units to be produced, the number of detection cycles, and the number of times the time has been exceeded of the selected process are displayed. Here, the number of detection cycles indicates the number of times (the number of cycles) the process measured from the video in which the hands of the worker are displayed is repeated, and the number of times the time has been exceeded indicates the number of times the cycle time has exceeded a predetermined standard time among the number of cycles.

In addition, in the graph of the cycle time in the region c, the comment made by reception of input on the work video is displayed at a corresponding position on the graph. In the example of FIG. 3, the comment “the amount of air blow is large” input by the administrator is displayed in a balloon format at the top of the bar graph. Further, in the example of FIG. 3, in a case where equal to or more than a predetermined number of comments have been received, an option of selectively displaying the comment to be displayed is displayed as “display latest comment”.

As an example of selectively displaying the comment to be displayed by the third display unit 105, an option of selecting the person who has input the comment or an option of selecting the date on which the comment has been input may be displayed. Furthermore, in a case where equal to or more than a predetermined number of comments have been received, the third display unit 105 may display the graph in different colors or may display the comments on the already displayed video in different colors.

In the area d, for example, a work video obtained by capturing the hands of the worker and a video obtained by capturing the skilled worker skilled in one process are displayed side by side. The second display unit 103 may display a work video obtained by capturing the hands of the worker in the selected cycle and a model video of work in an overlapping manner. When “overlay display” on the administration screen of the administrator is selected, the second display unit 103 switches a state in which the two videos are displayed side by side and a state in which the two videos are displayed in an overlapping manner. By making either the model video or the work video translucent and displaying the model video and the work video in an overlapping manner, it is easy to grasp the difference between the two videos.

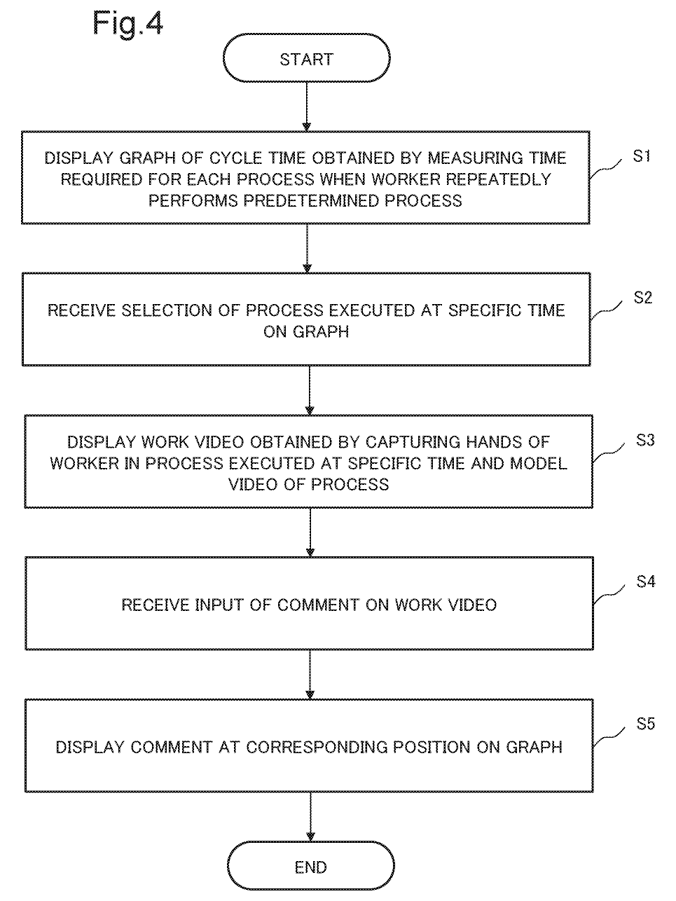

FIG. 4 illustrates an example of an operation flow of motion analysis processing in the motion analyzer 100. An operation of the motion analyzer 100 will be described with reference to FIG. 4.

The first display unit 101 displays a graph of the cycle time obtained by measuring the time required for each process while the worker repeatedly performs a predetermined process (step S1). Next, the first reception unit 102 receives selection of a process executed at a specific time on the graph (step S2). Subsequently, the second display unit 103 displays a work video obtained by capturing the hands of the worker in the process executed at the specific time and a model video of the process (step S3).

Next, the second reception unit 104 receives input of a comment on the work video (step S4). Finally, the third display unit 105 displays the comment at a corresponding position on the graph (step S5).

In the motion analyzer 100, the first reception unit 102 receives selection of the process executed at the specific time on the graph, and the second display unit 103 displays the work video obtained by capturing the hands of the worker in the process executed at the specific time and the model video of the process on the screen. Then, the third display unit 105 displays the comment received for the work video at the corresponding position on the graph.

This enables the administrator who manages the work of the worker to select a process which the administrator intends to check on the cycle time graph and input a noticed point as a comment while comparing the work video of the process with the model video. As a result, the input comment is displayed on the graph, which makes it possible to easily grasp a portion requiring improvement. In addition, the administrator can check the work of the worker as compared with the skilled worker while visually recognizing the comment information.

### First Modification

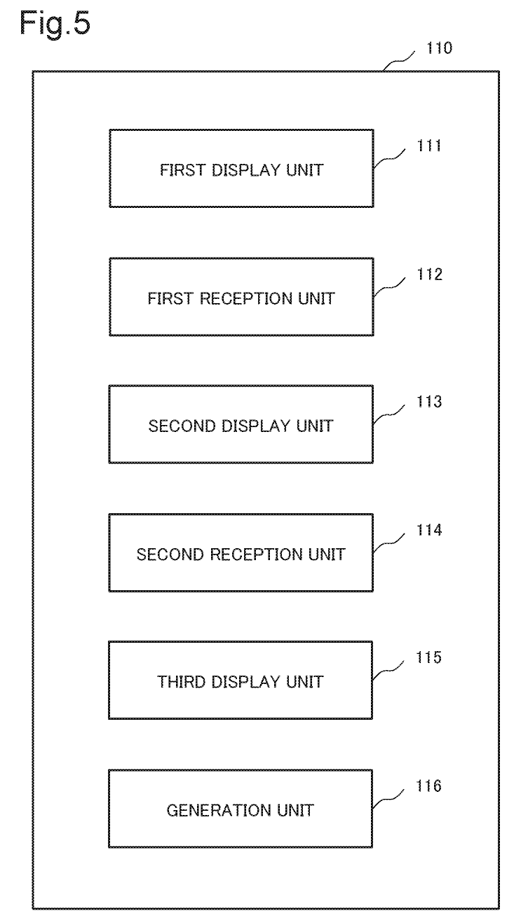

FIG. 5 is a diagram illustrating an example of a configuration of a motion analyzer 110. The motion analyzer 110 includes a first display unit 111, a first reception unit 112, a second display unit 113, a second reception unit 114, and a third display unit 115, and further includes a generation unit 116. In the configuration of the motion analyzer 110, a description of the same configuration as that of the first embodiment will be omitted.

The generation unit 116 is a means for generating a comment on the work video based on comparison between the model video and the work video. The generation unit 116 compares each frame of the work video with the model video and detects a portion where the motion of the worker is different from that of the model video. The generation unit 116 detects a difference in the position of the hand, the way of using the tool, the order of work, and the like by using, for example, a known image-recognition technique or a machine learning algorithm. The generation unit 116 may also compare the time required for each process or operation between the model video and the work video and specify a portion having a difference equal to or more than a predetermined value. Next, the generation unit 116 generates a comment using a natural language processing technique based on the detected difference and time difference. The generation unit 116 automatically generates a comment regarding an improvement point compared to the model video such as “component arrangement needs improvement” and “unnecessary movement between work A and work B”.

The second reception unit 114 receives the comment generated by the generation unit 116. In addition, the second reception unit 114 may display the generated comment on the administration screen of the administrator and receive its adoption, editing, or deletion operation.

In motion analyzer 110, the generation unit 116 generates a comment on the work video based on the comparison between the model video and the work video, and the second reception unit 114 receives the generated comment. In this manner, by automatically generating a comment and displaying the comment on the administration screen of the administrator, it is possible to generate an objective comment while reducing the burden on the administrator.

### Second Modification

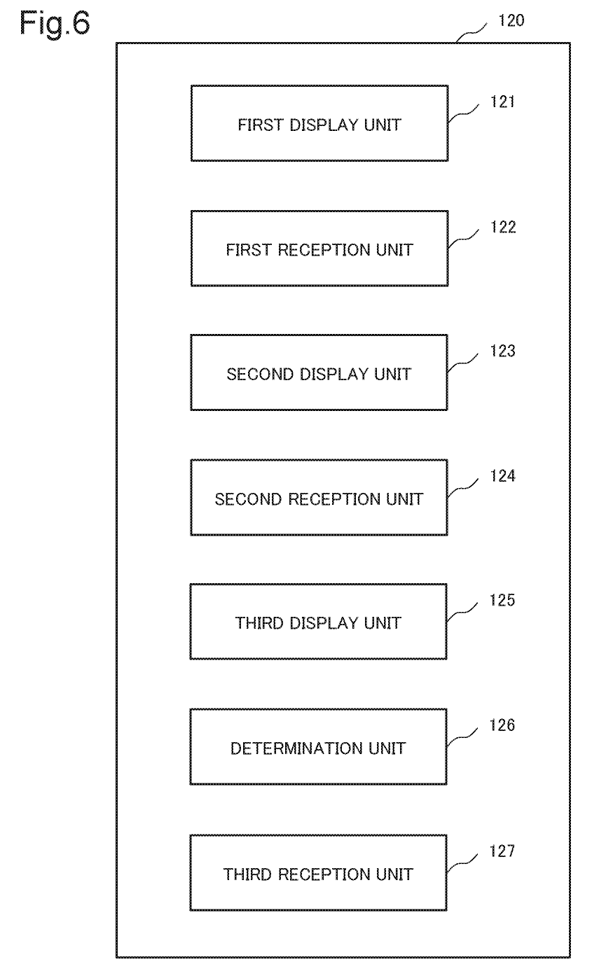

FIG. 6 is a diagram illustrating an example of a configuration of a motion analyzer 120. The motion analyzer 120 includes a first display unit 121, a first reception unit 122, a second display unit 123, a second reception unit 124, and a third display unit 125, and further includes a determination unit 126 and a third reception unit 127. In the configuration of the motion analyzer 120, a description of the same configuration as that of the first embodiment will be omitted.

The determination unit 126 is a means for determining the presence or absence of a work problem based on comparison between a model video of a process and a work video obtained by capturing the hands of the worker. The determination unit 126 compares each frame of the work video with the model video and detects a portion where the motion of the worker is different from that of the model. Specifically, the determination unit 126 detects an order error or omission in the work video using an image-recognition technique or a machine learning algorithm. The determination unit 126 compares the model video and the work video in each process and determines that a problem exists if a difference is equal to or more than a predetermined value exists. In addition, for example, in a case where a certain process takes longer than the model by equal to or more than a predetermined value, the determination unit 126 determines that a problem exists.

The third reception unit 127 is a means for receiving input of the presence or absence of a problem with respect to a determination result determined by the determination unit 126. The third reception unit 127 provides an interface for the administrator or a worker in a process subsequent to the process to be determined to check or correct the determination result and receives input of determination such as “problem exists” or “no problem exists” for each determination. The third reception unit 127 may display a screen for correcting the determination result of component assembling work or the like associated with code information, for example, if the administrator or the worker in the subsequent process reads the code information attached to the component flowing in the line.

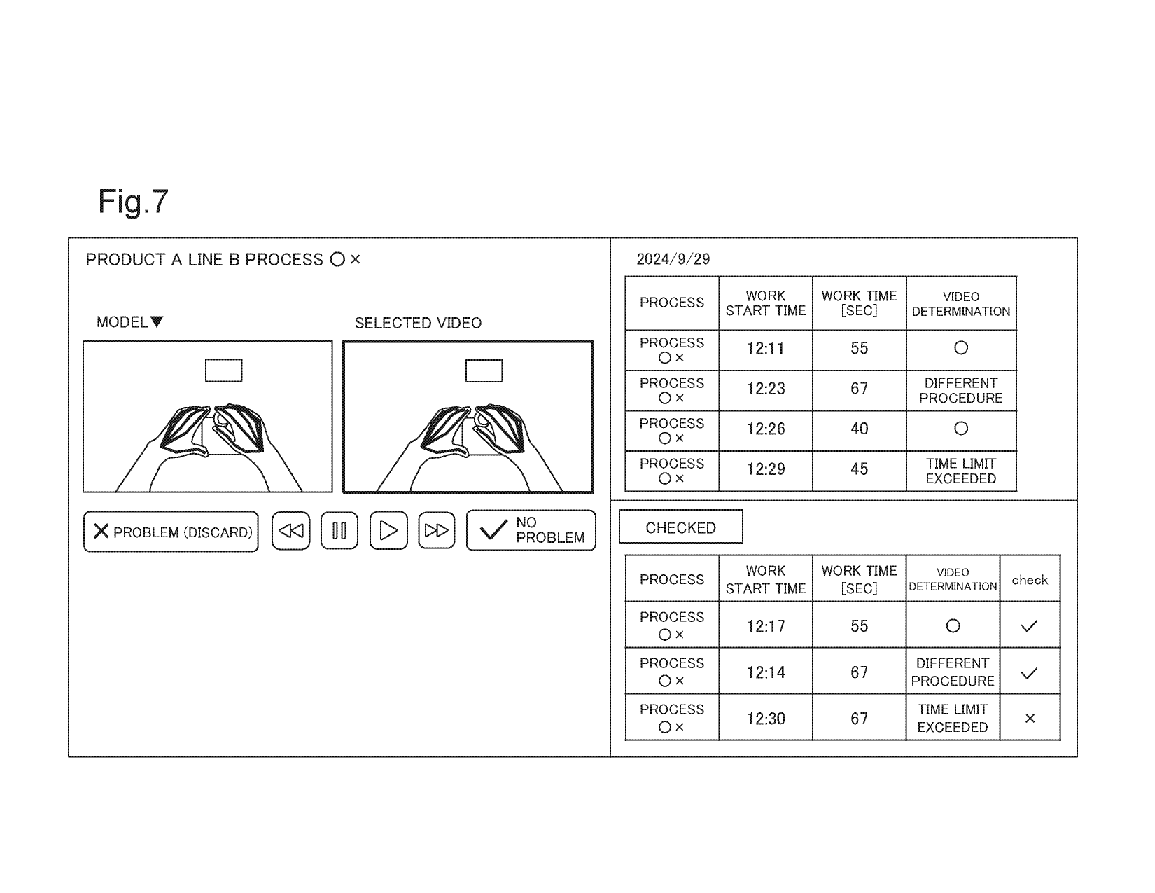

FIG. 7 is a diagram illustrating an example of a determination result check screen according to the present example embodiment. As illustrated in FIG. 7, the model video and the work video are displayed side by side on the left side of the screen, and buttons that can select “problem (discard)” and “no problem” are arranged below the model video and the work video. In addition, lists of processes to be checked and checked processes are displayed on the right side of the screen, and the process name, the work starts time, the work time, and the determination result by a video are displayed in each list. In a case where a problem in the determination result by the video exists, the reason why it is determined that a problem exists such as “different procedure” or “time limit exceeded” is displayed.

In motion analyzer 120, the third reception unit 127 receives input of the presence or absence of a problem with respect to a determination result determined by the determination unit 126. As a result, a more reliable determination result can be obtained by adding a determination based on human experience to the determination result on the presence or absence of a work problem obtained by comparison with the model video.

### Second Example Embodiment

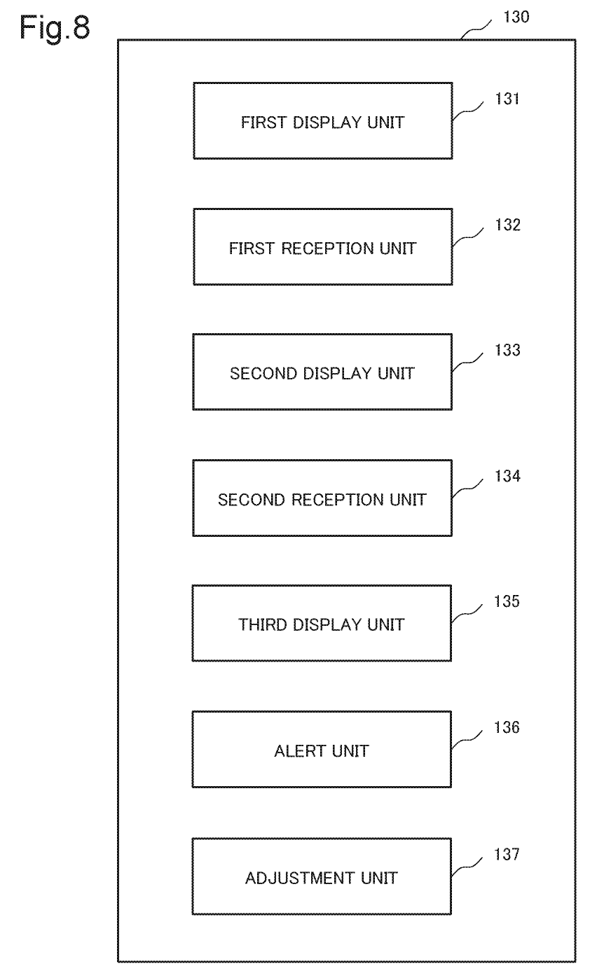

FIG. 8 is a diagram illustrating an example of a configuration of a motion analyzer 130. The motion analyzer 130 includes a first display unit 131, a first reception unit 132, a second display unit 133, a second reception unit 134, and a third display unit 135, and further includes an alert unit 136 and an adjustment unit 137. In the configuration of the motion analyzer 130, a description of the same configuration as that of the first embodiment will be omitted.

The alert unit 136 is a means for outputting an alert regarding a deterioration in cycle detection accuracy in a case where there is a difference equal to or more than a predetermined value between a theoretical value of the number of cycles and the measured number of cycles. The theoretical value of the number of cycles is the number of times of work scheduled to be repeated within a predetermined period and the number of units to be produced. The measured number of cycles is the number of repetitions of work measured from the start and end of the work detected from a video obtained by capturing the hands of the worker. The alert unit 136 calculates a difference between the theoretical value and the measured value, and outputs an alert of a deterioration in accuracy if the difference is equal to or more than a predetermined number of times. For example, the alert unit 136 displays a message indicating that a deterioration in the accuracy of the number of cycles has been detected on the administration screen of the administrator.

The adjustment unit 137 is a means for adjusting a threshold used for cycle detection in a case where there is a difference equal to or more than a predetermined value between the theoretical value of the number of cycles and the measured number of cycles. The threshold is a threshold for detecting start and end of work from a video obtained by capturing the hands of the worker, and if the detected number of cycles is smaller than the theoretical value by equal to or more than a predetermined number of times, conditions of the threshold are loosened. More specifically, the adjustment unit 137 loosens the conditions of the threshold and repeatedly performs a cycle detection test on an unannotated model video of about 10 to 20 cycles and sets a value at which failure in cycle detection does not occur as the threshold. However, the method of adjusting the threshold is an example, and the method is not limited to this.

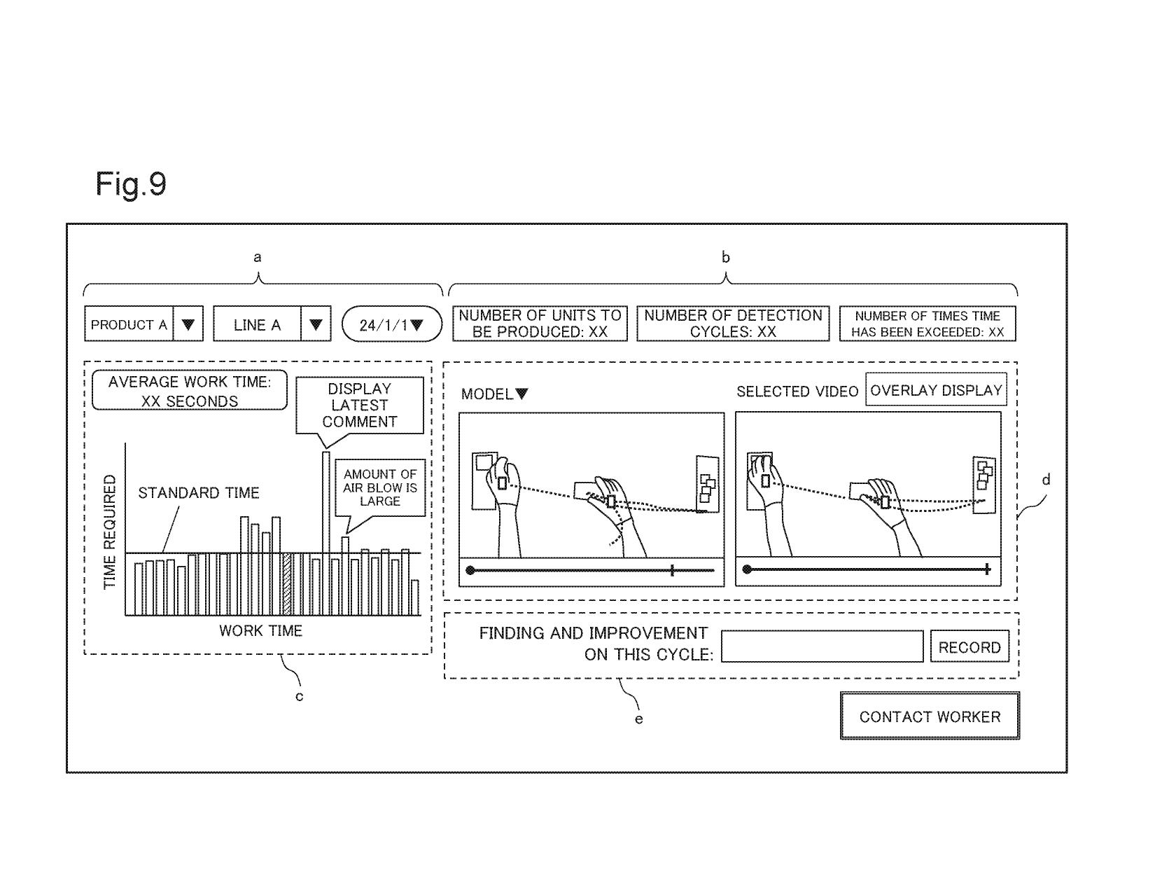

The first display unit 131 is a means for highlighting the time point at which the threshold is adjusted on the graph. FIG. 9 illustrates an example of a management screen of an administrator in the present example embodiment. As illustrated in FIG. 9, it is assumed that there is a portion where the work time is continuously longer than the standard time on the graph of the cycle time, and there is a possibility that failure in cycle detection occurs. In this case, the adjustment unit 137 adjusts the threshold used for cycle detection. Then, the first display unit 131 highlights the time point at which the threshold is adjusted on the graph. In the example of FIG. 9, a hatched pattern is applied to the bar graph at the time where the threshold is adjusted.

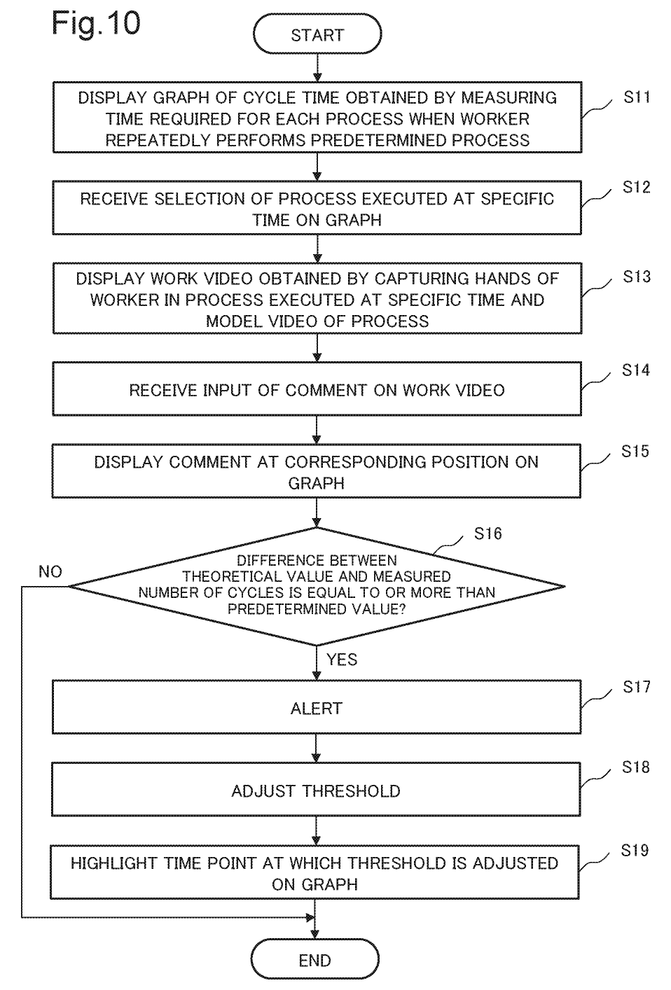

FIG. 10 illustrates an example of an operation flow of motion analysis processing in motion analyzer 130.

An operation of the motion analyzer 130 will be described with reference to FIG. 10. S11 to S15 in FIG. 10 are the same flows as S1 to S5 in FIG. 4.

The first display unit 131 displays a graph of the cycle time obtained by measuring the time required for each process while the worker repeatedly performs a predetermined process (step S11). Next, the first reception unit 132 receives selection of a process executed at a specific time on the graph (step S12). Subsequently, the second display unit 133 displays a work video obtained by capturing the hands of the worker in the process executed at the specific time and a model video of the process (step S13). Next, the second reception unit 134 receives input of a comment on the work video (step S14). Subsequently, the third display unit 135 displays the comment at a corresponding position on the graph (step S15). Next, the alert unit 136 outputs an alert regarding a deterioration in cycle detection accuracy (step S17) in a case where there is a difference equal to or more than a predetermined value between a theoretical value of the number of cycles and the measured number of cycles (step S16; YES). Subsequently, the adjustment unit 137 adjusts the threshold used for cycle detection (step S18). Finally, the first display unit 131 highlights the time point at which the threshold is adjusted on the graph (step S19). On the other hand, in a case where there is no difference equal to or more than the predetermined value between the theoretical value of the number of cycles and the measured number of cycles (step S16; NO), the flow ends.

In the motion analyzer 130, in a case where there is a difference equal to or more than the predetermined value between the theoretical value of the number of cycles and the measured number of cycles, the adjustment unit 137 adjusts the threshold used for cycle detection, and the first display unit 131 highlights the time point at which the threshold is adjusted on the graph. As a result, the administrator can visually check the influence brought by the adjustment of the threshold.

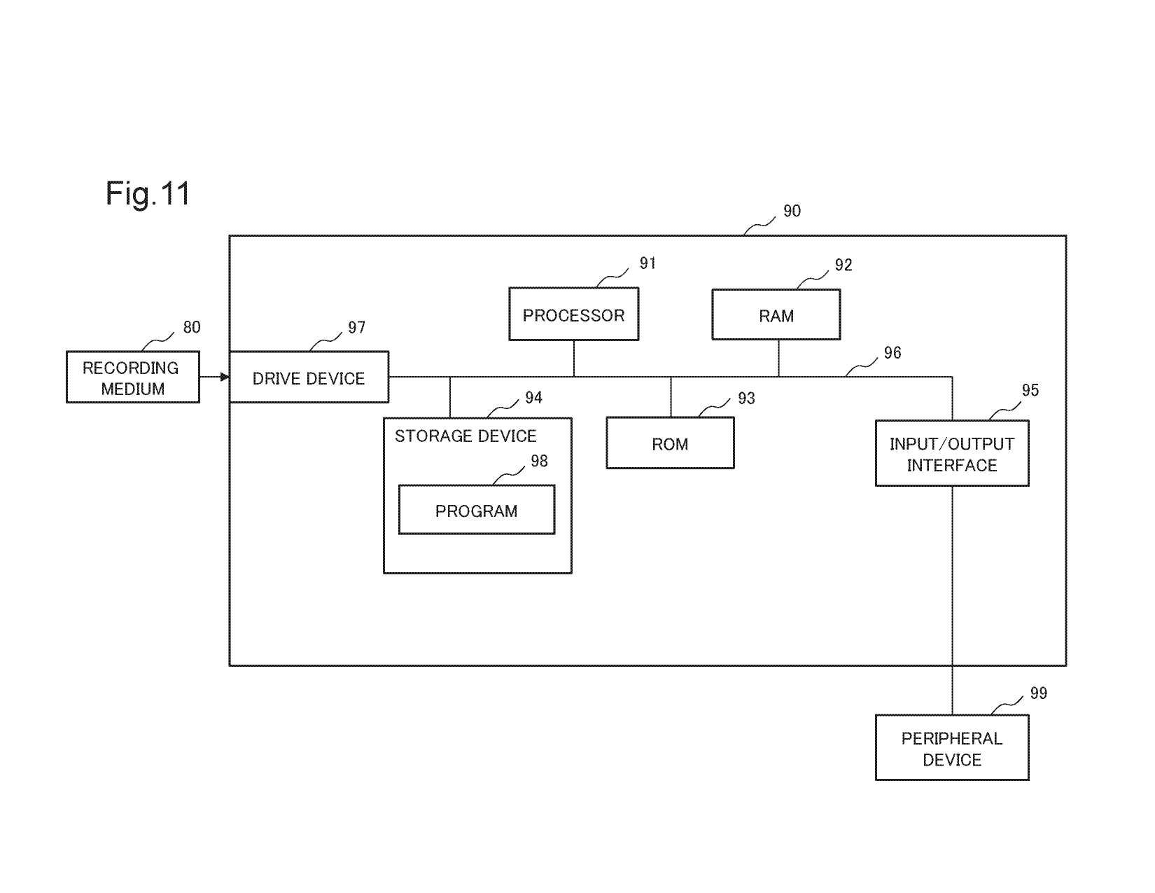

Each process in the motion analyzer can be enabled by executing a computer program on a computer device. FIG. 11 is a block diagram illustrating an example of a hardware configuration of a computer device constituting the motion analyzer 100 according to each example embodiment. In computer device 90, the motion analyzer and the motion analysis method described in the example embodiments are implemented. For example, the motion analyzer 100 and the like described in the example embodiments may have the hardware configuration illustrated in FIG. 11.

As illustrated on FIG. 11, computer device 90 includes a processor 91, a random-access memory (RAM) 92, a read only memory (ROM) 93, a storage device 94, an input/output interface 95, a bus 96, and a drive device 97. The motion analyzer and the like may be implemented by multiple electric circuits.

The storage device 94 stores a program (computer program) 98. The processor 91 executes program 98 of the motion analyzer 100 using RAM 92. Specifically, for example, the program 98 includes a program that causes a computer to execute the processing illustrated in FIGS. 4 and 10, for example. When processor 91 executes the program 98, the function of each configuration of the motion analyzer 100 is implemented. The program 98 may be stored in the ROM 93. The program 98 may be recorded in a recording medium 80 and read by the drive device 97 or may be transmitted from an external device (not illustrated) to the computer device 90 via a network (not illustrated).

The input/output interface 95 exchanges data with a peripheral device (such as a keyboard, a mouse, or a display device) 99. The input/output interface 95 functions as a means for acquiring or displaying data. The bus 96 connects the components with each other.

There are various modifications of the method for implementing the motion analyzer 100. For example, each of the components included in the motion analyzer 100 can be implemented as a dedicated device.

The motion analyzer can be implemented based on a combination of multiple devices.

A processing method for causing a recording medium to record a program for implementing each component in the function of each example embodiment, reading the program recorded in the recording medium as a code, and causing a computer to execute the program is also included in the scope of each example embodiment. That is, a computer-readable recording medium is also included in the scope of each example embodiment. The recording medium recording the above-described program and the program itself are also included in each example embodiment.

The recording medium is, for example, a floppy (registered trademark) disk, a hard disk, an optical disk, a magneto-optical disk, a compact disc (CD)-ROM, a magnetic tape, a nonvolatile memory card, or a ROM, but is not limited to this example. The program recorded in the recording medium is not limited to a program for executing processing by itself, and programs that run on an operating system (OS) to execute processing in cooperation with other software and functions of an extension board are also included in the scope of each example embodiment.

While the invention of the present application has been described with reference to the example embodiments, the invention of the present application is not limited to these example embodiments. It will be understood by those of ordinary skill in the art that various changes in form and details may be made therein without departing from the spirit and scope of the invention of the present application as defined by the claims.

Some or all of the above-described example embodiments may be described as the following supplementary notes but are not limited to the following.

### Supplementary Note 1

A motion analyzer including:

a first display means for displaying a graph of cycle time obtained by measuring time required for each process while a worker repeatedly performs a predetermined process;

a first reception means for receiving selection of a process executed at a specific time on the graph;

a second display means for displaying, on a screen, a work video obtained by capturing a hand of the worker in the process executed at the specific time and a model video of the process;

a second reception means for receiving input of a comment on the work video; and

a third display means for displaying the comment at a corresponding position on the graph.

### Supplementary Note 2

The motion analyzer described in Supplementary Note 1, further including

a generation means for generating the comment based on comparison between the model video and the work video,

in which the second reception means receives input of the generated comment.

### Supplementary Note 3

The motion analyzer described in Supplementary Note 1, in which the third display means displays the graph in a different color if equal to or more than a predetermined number of comments have been received.

### Supplementary Note 4

The motion analyzer described in Supplementary Note 1, in which the third display means selectively displays a comment to be displayed if equal to or more than a predetermined number of comments have been received.

### Supplementary Note 5

The motion analyzer described in Supplementary Note 1, in which the second display means displays the work video obtained by capturing the hand of the worker in the selected process and the model video of the process in an overlapping manner.

### Supplementary Note 6

The motion analyzer described in Supplementary Note 1, further including:

a determination means for determining presence or absence of a work problem in the process based on comparison between the model video and the work video; and

a third reception means for receiving input of presence or absence of a problem with respect to the determination result.

### Supplementary Note 7

The motion analyzer described in Supplementary Note 1, further including an alert means for outputting an alert regarding a deterioration in cycle detection accuracy in a case where there is a difference equal to or more than a predetermined value between a theoretical value of the number of cycles and the measured number of cycles.

### Supplementary Note 8

The motion analyzer described in Supplementary Note 7, further including an adjustment means for adjusting a threshold used for cycle detection,

in which the first display means highlights a time point at which the threshold is adjusted on the graph.

### Supplementary Note 9

A motion analysis method causing a computer to execute processing including:

displaying a graph of cycle time obtained by measuring time required for each process while a worker repeatedly performs a predetermined process;

receiving selection of a process executed at a specific time on the graph;

displaying, on a screen, a work video obtained by capturing a hand of the worker in the process executed at the specific time and a model video of the process;

receiving input of a comment on the work video; and

displaying the comment at a corresponding position on the graph.

### Supplementary Note 10

A motion analyzer program causing a computer to execute processing including:

displaying a graph of cycle time obtained by measuring time required for each process while a worker repeatedly performs a predetermined process;

receiving selection of a process executed at a specific time on the graph;

displaying, on a screen, a work video obtained by capturing a hand of the worker in the process executed at the specific time and a model video of the process;

receiving input of a comment on the work video; and

displaying the comment at a corresponding position on the graph.

Some or all of the configurations described in Supplementary Notes 2 to 8 dependent on the above-described Supplementary Note 1 can also be dependent on Supplementary Notes 9 and 10 by the same dependency relationship as in Supplementary Notes 2 to 8. Some or all of the configurations described as Supplementary Notes can be similarly dependent on not only Supplementary Notes 1, 9, and 10, but also diverse pieces of hardware and software, various recording means for recording software, or systems without departing from the above-described example embodiments.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

What is claimed is:

1. A motion analyzer comprising:
one or more memories storing instructions; and
one or more processors configured to execute the instructions to:
display a graph of cycle time obtained by measuring time required for each process while a worker repeatedly performs a predetermined process;
receive selection of a process executed at a specific time on the graph;
display, on a screen, a work video obtained by capturing a hand of the worker in the process executed at the specific time and a model video of the process;
receive input of a comment on the work video; and
display the comment at a corresponding position on the graph.

2. The motion analyzer according to claim 1, wherein
the one or more processors are further configured to execute the instructions to:
generate the comment based on comparison between the model video and the work video; and
receive input of the generated comment.

3. The motion analyzer according to claim 1, wherein the one or more processors are configured to execute the instructions to display the graph in a different color if equal to or more than a predetermined number of comments have been received.

4. The motion analyzer according to claim 1, wherein the one or more processors are configured to selectively display a comment if equal to or more than a predetermined number of comments have been received.

5. The motion analyzer according to claim 1, wherein the one or more processors are configured to display the work video obtained by capturing the hand of the worker in the process executed at the specific time and the model video of the process in an overlapping manner.

6. The motion analyzer according to claim 1, wherein
the one or more processors are further configured to execute the instructions to:
determine presence or absence of a work problem in the process based on comparison between the model video and the work video; and
receive input of presence or absence of a problem with respect to the determination result.

7. The motion analyzer according to claim 1, wherein the one or more processors are configured to output an alert regarding a deterioration in cycle detection accuracy in a case where there is a difference equal to or more than a predetermined value between a theoretical value of the number of cycles and the measured number of cycles.

8. The motion analyzer according to claim 7, wherein
the one or more processors are further configured to execute the instructions to:
adjust a threshold used for cycle detection; and
highlight a time point at which the threshold is adjusted on the graph.

9. A motion analysis method comprising:
by a computer,
displaying a graph of cycle time obtained by measuring time required for each process while a worker repeatedly performs a predetermined process;
receiving selection of a process executed at a specific time on the graph;
displaying, on a screen, a work video obtained by capturing a hand of the worker in the process executed at the specific time and a model video of the process;
receiving input of a comment on the work video; and
displaying the comment at a corresponding position on the graph.

10. A non-transitory recording medium recording a program for causing a computer to execute:
displaying a graph of cycle time obtained by measuring time required for each process while a worker repeatedly performs a predetermined process;
receiving selection of a process executed at a specific time on the graph;
displaying, on a screen, a work video obtained by capturing a hand of the worker in the process executed at the specific time and a model video of the process;
receiving input of a comment on the work video; and
displaying the comment at a corresponding position on the graph.
